(19) United States
(12) Patent Application Publication
(10) Pub. No.: US 2008/0204191 A1
(43) Pub. Date: Aug. 28, 2008

(54) System and method for controlling information access on a mobile platform

(75) Inventor: Ansaf I. Alrabady, Livonia, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/678,082

(22) Filed: Feb. 23, 2007

(51) Int. Cl. G05B 19/00

(52) U.S. Cl. 340/5.21

(57) ABSTRACT

A method and system are provided for controlling extra-vehicle communications to a device of a mobile platform. The method comprises establishing a policy comprising attributes for permitting communications to the device, the attributes having selectable states. Access to communicate with the device is authorized based upon a least privilege of the selectable states of the attributes. An information requestor is permitted to communicate with the device when the access is authorized, and the information requestor is denied access to the device when one of the selectable states of the attributes is not satisfied

### TECHNICAL FIELD

The present invention relates to systems and methods for communicating with devices in a mobile platform, and, more specifically, the present invention concerns a system and method for controlling communications thereto.

### BACKGROUND OF THE INVENTION

Mobile platforms, including motor vehicles, are being equipped with electronically controlled systems and devices which provide desirable features for the operator and others. For example, there is an expanding application of wireless communication services for mobile platforms to provide features related to navigation and roadside assistance. Related features can include wireless communications for transactions with stationary devices such as toll booths and automated fueling stations. Other features can include access to localized broadcasts for traffic, weather, and entertainment. Furthermore, there can be a need for service personnel to access specific information on the vehicle to determine a need to perform scheduled maintenance or repairs. Current wireless communications systems comprise point-to-point communications, e.g., cellular systems, and satellite-based radio broadcasting systems, which use geostationary satellites to communicate. Wired communications can comprise a connection to a programming tool via a diagnostic link, e.g., at a manufacturing or assembly facility, a dealership, or an authorized repair facility. Remote wireless programming of vehicle control modules has been introduced, which allows for greater programming flexibility. Information security is accomplished using password and cryptographic authentication mechanisms for controlling access to the control modules.

Access to the mobile platforms is limited using password and cryptographic access-control mechanisms. However, the access control can be compromised, and therefore there is a need for an enhanced method to manage and control access to obtain information from control modules on mobile platforms.

Thus, an improved access-control mechanism is needed to more effectively manage and control access to control modules on vehicular or other mobile platforms.

### SUMMARY OF THE INVENTION

In accordance with an aspect of the invention, there is provided a method for controlling communications to a device of a mobile platform. The method comprises establishing a policy comprising attributes for permitting communications to the device, the attributes having selectable states. Access to communicate with the device is authorized based upon a least privilege of the selectable states of the attributes. An information requestor is permitted to communicate with the device when the access is authorized, and the information requestor is denied access to the device when one of the selectable states of the attributes is not satisfied.

These and other aspects of the invention will become apparent to those skilled in the art upon reading and understanding the following detailed description of the embodiments.

### BRIEF DESCRIPTION OF THE DRAWINGS

The invention may take physical form in certain parts and arrangement of parts, the preferred embodiment of which will be described in detail and illustrated in the accompanying drawings which form a part hereof, and wherein:

FIG. 1 is a schematic system diagram, in accordance with the present invention; and,

FIG. 2 is a schematic block diagram, in accordance with the present invention.

### DESCRIPTION OF THE EMBODIMENTS OF THE INVENTION

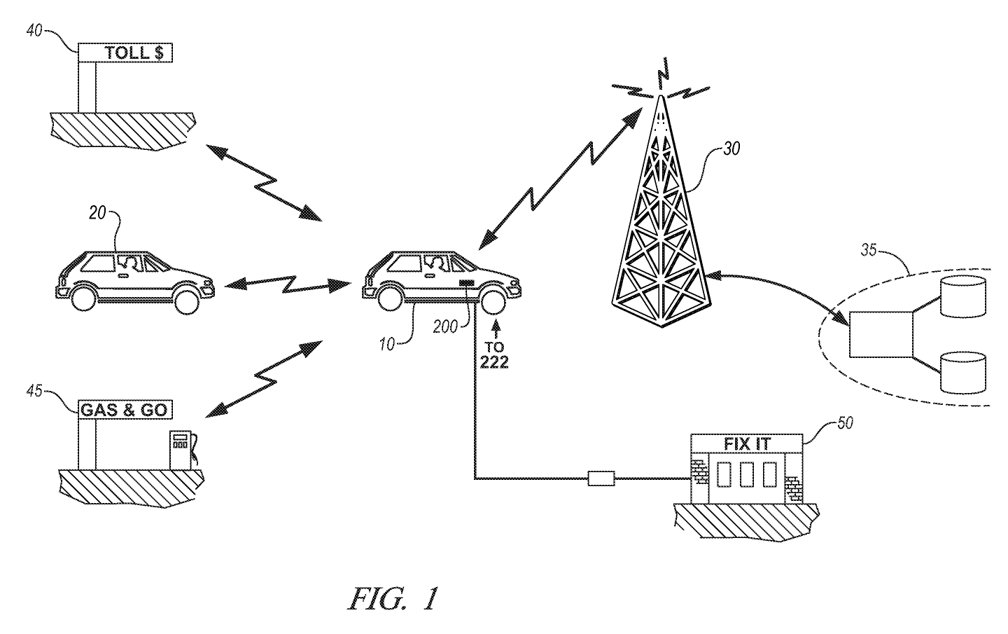

Referring now to the drawings, wherein the showings are for the purpose of illustrating the invention only and not for the purpose of limiting the same, FIG. 1 depicts a communications system for a mobile platform which has been constructed in accordance with an embodiment of the present invention. The mobile platform depicted in the embodiment comprises a land-based motor vehicle 10 consisting of a powertrain system, a chassis and suspension system, and a passenger compartment, and a control scheme 200 all enclosed in a body. The control scheme 200 comprises a plurality of control modules, sensors, and actuators operative to monitor vehicle operation, determine operator requests and control operation thereof. The control modules comprise electronic devices having preprogrammed algorithms and calibrations for controlling and managing various aspects of vehicle operation. The control scheme includes hardware devices and control algorithms which facilitate extra-vehicle communications, comprising on-board telematics devices operative to communicate wirelessly with one or more external devices and systems. The vehicle is preferably equipped for hardwired communications with vehicle service and maintenance facilities 50 through a service plug-in connector 222.

The extra-vehicle communications can take the form of a request from an external source seeking specific information originating from a subsystem of the vehicle, or it can take the form of a request from the external source seeking to communicate specific information originating from outside the vehicle to a subsystem of the vehicle The extra-vehicle communications can include various and sundry extra-vehicle information requestors. The extra-vehicle requesters can comprise one or more other vehicles 20 which employ known short-range communications systems such as DSRC (dedicated short-range communications), on a vehicle so equipped. The extra-vehicle requesters can comprise communications networks 30 consisting of land-based fixed systems and satellite systems that may have access to Internet systems or some form of private network system, depicted generally as 35, which provide functionalities such as vehicle communications and global positioning, and can include emergency vehicle information, public safety messages, cellular phone communications, and other forms of broadcast and direct messages. Communications protocols between the vehicle 10 and the various extra-vehicle requesters can comprise any one of various known protocols, including, e.g., those compliant with the IEEE 802.11 Wireless Networking standard, operating at 2.4 GHz and capable of communicating 1 megabit per second (Mbit/sec) of information. The extra-vehicle requesters can comprise in-transit enterprise units such as toll-booths 40 and automated fueling stations 45. The extra-vehicle requesters can comprise vehicle service and maintenance facilities 50 to monitor and identify on-vehicle fault codes, service intervals, provide reprogramming capability, and other functions. Extra-vehicle requestors can further include systems not specifically identified, including e.g., fleet-management systems.

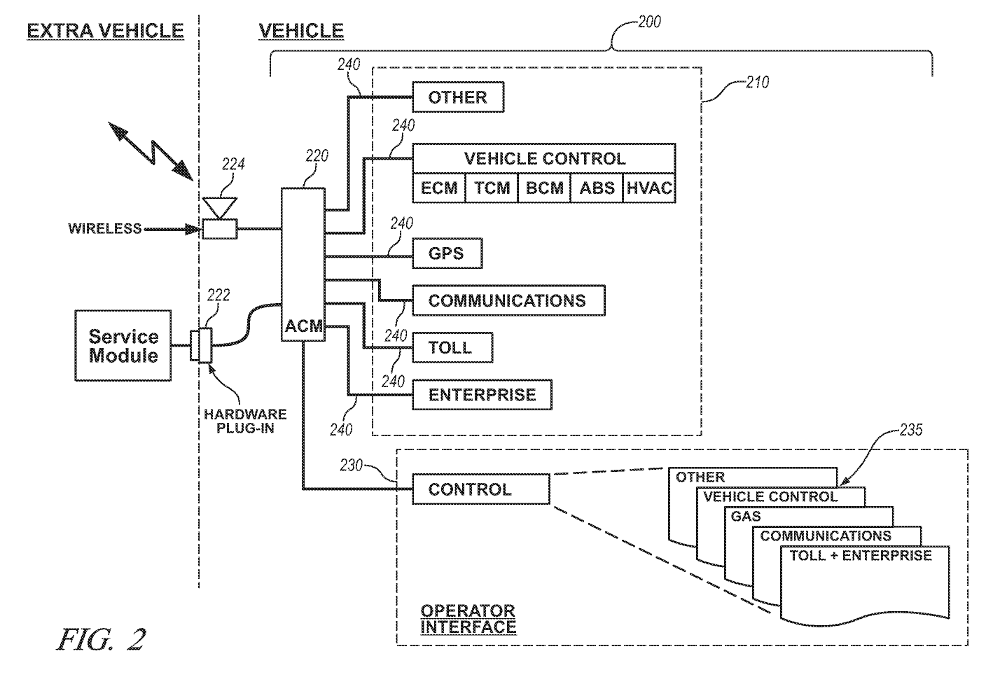

Referring now to FIG. 2, a schematic diagram illustrates a non-limiting embodiment of the control scheme 200 in block diagram form for controlling ability of the extra-vehicle communications requesters to gain access to establish communications with specific control modules in order to obtain information which originates from devices and subsystems of the motor vehicle 10, and to communicate specific information to one or more of the plurality of devices and subsystems of the motor vehicle 10. The extra-vehicle requestors communicate to and through an access control module (ACM) 220 of the control scheme via a wireless transceiver 224 or the hardwired service plug-in connector 222, which are elements of the vehicle platform. The ACM 220 acts as a communications gatekeeper by interacting with an operator interface 230 to implement policies to authorize and control access to the control modules of the distributed control module architecture 210 and permit communication to each of the control modules and thus one or more subsystems. The operator interface 230 is operative to selectively establish specific state values for attributes of the policies, to authorize and control access to specific information originating in one of the subsystems and permit communication of specific information to one or more of the plurality of devices and subsystems of the motor vehicle 10. Communications to each of the control modules of the distributed control module architecture 210 is accomplished via one or more internal communications buses, depicted generally as 240. It is understood that the ACM 220 and the operator interface 230 control communications access to each of the control modules and subsystems. The individual control modules preferably have specific protocols by which they effect actual communications, and typically include user verifications and other authenticating protocols such as cryptographic access-control mechanisms, the design and execution of which are known to a skilled practitioner.

The ACM is depicted as a unitary component identified as item 220, but it is understood that the ACM can comprise a plurality of different configurations, including hardware communications and software gates that function in an on/off manner to permit flow of electrical signals between the extra-vehicle communicator and the targeted control module on the vehicle. Thus, although depicted as a unitary device, the ACM can comprise a software and/or hardware control scheme that is an element of communications to each control module which communicates with extra-vehicle devices, or, alternatively, a control scheme that is an element of a local area network communications bus. By way of example, the ACM can comprise a single electronically controlled line selectively operative to connect a signal line to electrical ground in one state, and permits communications in a second state. The ACM device and control scheme are implemented based upon system-appropriate considerations including cost and presence of hardware and software controls.

The distributed control module architecture 210 preferably comprises a plurality of control modules effective to control and manage aspects of subsystems related to vehicle operation, dependent upon vehicle content. The control modules may comprise a plurality of hardware devices, or an individual hardware device which generates virtual control module capability for various vehicle subsystems. Some specific vehicle subsystems comprise those for vehicle operation, including, e.g., an engine control module (ECM), a transmission control module (TCM), a body/suspension control module (BCM), an anti-lock braking/traction control module (ABS), and a climate control module (HVAC). There can be a subsystem for vehicle global position sensing (GPS) and route management. There can be a subsystem related to operator communications, e.g., a cellular telephone system (COMMUNICATIONS). There can be a tollway payment subsystem (TOLL). There can be a subsystem related to enterprise management, such as for automated payment at refueling centers (ENTERPRISE). There can be other subsystems adapted for specific operator or regional needs.

Policies for authorizing access to communicate specific information and permitting communication of specific information to one or more of the plurality of devices and systems of the motor vehicle 10 are generated in the operator interface 230. A vehicle operator or system administrator interacts and provides inputs to the operator interface 230 to selectively establish policies having specific states for attributes of the various policies to authorize and to permit access to specific control modules and subsystems, and to permit communication of specific information to one or more of the plurality of control modules, devices and systems of the motor vehicle 10. Policies can also include default states for one or more of the attributes.

The operator interface 230 preferably comprises a user input and a feedback system. The user input is in the form of a graphic user interface or other interactive device, comprising, e.g., a touch-activated screen keypad, touch screen, or microphone with voice recognition capability, or some combination thereof. The feedback and verification system is preferably in the form of the graphic user interface or an auditory device/speaker. Preferably there is unique user input to establish a policy for each of the control modules and/or subsystems, depicted as 235. Access to provide inputs for attributes for specific policies via the operator interface preferably comprises a vehicle key, a password, and/or other mechanisms available to and controlled by a system administrator. The attributes can comprise such parameters as time of day, elapsed vehicle running time, vehicle direction, vehicle speed, vehicle position (GPS), vehicle operating status (Key ON/OFF), presence of a diagnostic trouble code (DTC), status of passenger compartment door lock, operating gear (PRNDL), credit card information, payment authorization verification, among others.

The extra-vehicle requesters can comprise a tollbooth operation, a refueling station, a service and maintenance center, a factory-authorized repair center, a traffic-management center, among others.

The specific information transmitted from the vehicle can include vehicle operating status (ON/OFF), location, direction, and speed, DTCs (if any), credit/debit card payment authorization, PRNDL status, operator request for information, and others.

The specific information transmitted to the vehicle can comprise GPS and traffic information, a vehicle unlock command, and, updated programming for an EEPROM or other programmable memory device.

The invention comprises a method for controlling communications to one of the subsystems, typically contained in one of the electronic control modules. For purposes of this invention, communications can be authorized and permitted. Communications are said to be authorized when the vehicle operator and/or system administrator establish states for attributes, and the attribute states have been satisfied, but there has been no specific request for communications with one of the control modules or subsystems. Communications are said to be permitted when all the selectable states have been met or satisfied and a specific extra-vehicle requester attempts to establish communications with the vehicle.

In operation, the policy is established for authorizing and permitting communications to the electronic device, the policy comprising the attributes. Each of the attributes has a state, i.e., a value, which is selected during vehicle manufacture, or during in-use operation of the vehicle. One or more of the attributes can be set by a vehicle control engineer or designer during vehicle development and testing, based upon observed criteria. One or more of the attributes can be set by a vehicle manufacturer during vehicle manufacturing process. One or more of the attributes can be set by a vehicle owner or operator during vehicle use, taking into account owner/operator preferences and information. One or more of the attributes can be set by a vehicle service technician during vehicle service, related to reprogramming or other vehicle servicing issues. Creation of a policy effectively establishes what authority is required to gain access to communicate with the electronic device, and is preferably based upon a least privilege of the selectable states of the attributes. The least privilege of the selectable states is meant to indicate that an extra-vehicle information requestor attempting to communicate with the vehicle shall be permitted to establish communications when the access is authorized, i.e., when each and every one of the selectable states of the attributes is satisfied. Furthermore, the least privilege of the selectable states indicates that an extra-vehicle information requestor attempting to communicate with the vehicle shall be denied access to establish communications when any one or more of the selectable states of the attributes is not satisfied.

By way of example, in operation, when a policy includes a time-of-day limitation, access to the subsystem controlled by that policy authorizes communications only within the allowable time-of-day window, and permits an extra-vehicle information requester to attempt to establish communications with one of the subsystems during that time period. Similarly, when a policy includes a directional limitation, e.g. north or south, access to the subsystem controlled by that policy authorizes communications only when the vehicle is traveling in the allowable direction, and permits an extra-vehicle information requester to attempt to establish communications with the subsystem only when the vehicle is traveling in the allowable direction.

By way of example, a policy for accessing one of the vehicle control modules using a wireless communications system can include vehicle speed, such that access to one of the systems is permitted only when vehicle speed is within a predetermined range, or is at zero speed. A specific example is permitting access to one of the vehicle control modules only when vehicle speed is at zero speed. This can be further complicated by permitting access to a vehicle control module to read DTCs at a range of speeds, but prohibiting access to the vehicle control module to reprogram a memory device or reset a DTC only when the vehicle speed is zero. This operation can serve to prevent unauthorized access that could be disruptive to vehicle operation.

By way of example, in operation, when a policy includes a time-of-day limitation, access to the subsystem controlled by that policy authorizes communications only within the allowable time-of-day window, and permits an extra-vehicle information requester to attempt to establish communications with one of the subsystems during that time period. Similarly, when a policy includes a directional limitation, e.g. north or south, access to the subsystem controlled by that policy authorizes communications only when the vehicle is traveling in the allowable direction, and permits an extra-vehicle information requestor to attempt to establish communications with the subsystem only when the vehicle is traveling in the allowable direction.

Authorizing the information requestor to have access to the device based upon a least privilege of the selectable states of the attributes comprises authorizing access to the device only when all the allowable states of the attributes of the established policy are achieved, satisfied, or met. Thus, when the policy comprises multiple attributes and states, e.g. time of day and vehicle operational (Key-on), access to the subsystem controlled by that policy authorizes communications only when the vehicle satisfies all the attribute states, i.e., within the time-of-day window and the vehicle being operational, and permits an extra-vehicle information requestor to attempt to establish communications with the subsystem only when all the attribute states are satisfied.

The invention has been described with specific reference to the embodiments and modifications thereto. Further modifications and alterations may occur to others upon reading and understanding the specification. It is intended to include all such modifications and alterations insofar as they come within the scope of the invention.

1. Method for controlling access to a device of a mobile platform, comprising:
establishing a policy comprising attributes for accessing the device, the attributes having selectable states; and,
authorizing access to communicate with the device based upon a least privilege of the selectable states of the attributes.

2. The method of claim 1, wherein authorizing access to communicate with the device comprises authorizing an extra-vehicle requester to have access to the device to establish communications therewith.

3. The method of claim 2, wherein the device is operative to execute a communications protocol to establish communications with the extra-vehicle requester.

4. The method of claim 2, further comprising authorizing the extra-vehicle requester to attempt to establish communications with a control module of the mobile platform to transmit information thereto.

5. The method of claim 4, further comprising authorizing the extra-vehicle requestor to have access to the device to attempt to establish communications to transmit information to reprogram the control module.

6. The method of claim 2, further comprising authorizing the information requester to attempt to establish communications with a control module of the mobile platform to elicit information therefrom.

7. The method of claim 6, further comprising authorizing the information requester to establish communications with the control module of the mobile platform to download diagnostic trouble codes.

8. The method of claim 6, further comprising authorizing the information requestor to establish communications with the control module of the mobile platform to download global position information therefor.

9. The method of claim 1, wherein authorizing access to communicate to the device based upon a least privilege of the selectable states of the attributes comprises authorizing access to communicate with the device only when all the attributes of the established policy are satisfied.

10. The method of claim 1, wherein the selectable states of the attributes comprise operator-selectable states.

11. The method of claim 10, wherein the operator-selectable states comprise one of time-of-day, vehicle key position, and vehicle direction.

12. The method of claim 1, wherein the selectable states of the attributes comprise system administrator-selectable states.

13. The method of claim 1, further comprising a system operative to implement the method.

14. Method for controlling communications to a subsystem of a mobile platform, comprising:
establishing a policy comprising attributes for accessing the subsystem, the attributes having selectable states; and,
permitting an information requester to attempt to communicate with the subsystem based upon a least privilege of the selectable states of the attributes.

15. The method of claim 14, wherein permitting the information requestor to attempt to communicate to the subsystem further comprises permitting the information requestor to attempt to establish communications to transmit information thereto.

16. The method of claim 14, wherein permitting the information requestor to attempt to communicate to the subsystem further comprises permitting the information requester to attempt to establish communications to elicit information therefrom.

17. Method for controlling communications to a device of a mobile platform, comprising:
establishing a policy comprising attributes for permitting communications to the device, the attributes having selectable states; and,
authorizing access to communicate with the device based upon a least privilege of the selectable states of the attributes;
permitting an information requester to communicate with the device when the access is authorized; and,
denying the information requestor access to the device when one of the selectable states of the attributes is not satisfied.

18. The method of claim 17, wherein the mobile device comprises a vehicular device.

19. The method of claim 17, wherein permitting an information requestor to communicate with the device when the access is authorized further comprises permitting the information requestor to establish communications with a subsystem of the device.
